(19) United States
(12) Patent Application Publication
(10) Pub. No.: US 2021/0402639 A1
(43) Pub. Date: Dec. 30, 2021

(54) Fully Automatic Sponge Chamfering Machine

(71) Applicant: Innovation Sound Technology Co., Ltd., Shenzhen, Guangdong (CN)

(72) Inventors: Shun Ming Yuen, Shenzhen, Guangdong (CN); Qingshan Tang, Shenzhen, Guangdong (CN); Xuegen Sun, Shenzhen, Guangdong (CN)

(21) Appl. No.: 17/256,636

(22) PCT Filed: Jan. 15, 2020
(86) PCT No.: PCT/CN2020/072205

§ 371 Date: Dec. 28, 2020

(30) Foreign Application Priority Data
Jan. 13, 2020 (CN) 202020060337.2

(51) Int. Cl. B26D 7/10; B26F 3/08; B08B 15/02; B26D 7/06; B26D 7/18; B26D 7/20; B26D 7/32

(52) U.S. Cl. CPC B26D 7/10; B26F 3/08; B08B 15/02; B26D 7/32; B26D 7/1863; B26D 7/20; B26D 7/06

(57) ABSTRACT

The application belongs to the technical field of hot angle-cutting automata for earmuff sponge of earphones, and discloses a fully automatic sponge chamfering machine, which comprises a rack, a man-machine interface and a button system set on the enclosure, a three-color alarm lamp fixed on the enclosure, a suction module set on the enclosure, a safety grating module set on the enclosure, and an air extraction module set on the enclosure. The application has high degree of automation, high positioning accuracy, and high work efficiency.

### FIELD OF THE INVENTION

The application relates to the technical field of a hot angle-cutting automata for earmuff sponge of earphones, in particular to a fully automatic sponge chamfering machine.

### BACKGROUND OF THE INVENTION

The traditional hot angle cutting for earphone earmuffs sponge is mainly completed by manual operation which features low efficiency, frequent feeding and reclaiming, high costs of manual labor. Moreover, the manual operation method is prone to deviations, resulting in very poor uniformity, poor cutting, poor product effect, and low rates of finished products. In most cases, because the cutting angle cannot be guaranteed to be uniform, the scrappage is high. In addition, oval products always cannot meet the length and width dimensions, which leads to low efficiency and high waste. Moreover, frequently and manually picking and placing materials causes great mental stress on operators. Due to hot cutting, sponge produces a lot of irritating smell when it burns, which affects the health of employees.

### CONTENT OF APPLICATION

The application is intended to overcome the existing defects by providing a fully automatic sponge chamfering machine, wherein materials are fed through a rotating disc, and product cutting, waste discharge, air extraction, and product extraction are simultaneously completed at different work stations. The entire movement process is completed automatically, thus realizing automatic feeding of products, all self-cutting, automatic waste discharge, automatic air extraction, and automatic reclaiming. The machine has high degree of automation, high positioning accuracy, high work efficiency, good product effect, and low production cost, being convenient, simple and fast in use. Hence, the application can effectively solve the problems in the background technology.

In order to solve the above technical problems, the present application provides the following technical solutions:

The present application provides a fully automatic sponge chamfering machine, consisting of:

A rack; and

An enclosure disposed on the rack; and

An air intake controller and a ventilation system arranged on the rack; and

A man-machine interface and a button system set on the enclosure; and

A three-color alarm lamp fixed on the enclosure; and

A suction module set on the enclosure; and

A safety grating module set on the enclosure; and

An air extraction module set on the enclosure; and No. 1 leakage module and no. 2 leakage module set on the enclosure; and

A hot-cutting module, sweeping module, blowing module, No. 1 cover-removing module, rotating module, No. 2 cover-removing module, No. 1 lifting module and No. 2 lifting module.

As a preferred technical solution of the application, the hot-cutting module includes:

A fixing frame, fixed to the upper part of the rack;

A Z-direction sliding table, set on one side of the fixing frame;

A XY conditioning mechanism, disposed on one side of the Z-direction sliding table;

A hot cutter, arranged under the XY conditioning mechanism, with one side connected with the air pipe beside the cutter;

A high block, placed below the air pipe beside the cutter;

A power cylinder, set on the upper part of the fixing frame.

As a preferred technical solution of the application, the sweeping module comprises:

A fixed seat, disposed on the upper part of the rack;

No. 2 cylinder, arranged below the fixed seat;

No. 1 cylinder, one end of which is connected to one end of the No. 2 cylinder

A broom, set under the No. 1 cylinder.

As a preferred technical solution of the application, the blowing module comprises: No. 1 upper fixing plate, set at the top of the rack;

A large column, the top of which is connected to the No. 1 upper fixing plate;

No. 1 lower fixing plate, located below the large column;

A hot cutting exhaust pipe, disposed in the upper part of the No. 1 lower fixing plate;

A column, one end of which is connected to the bottom of the No. 1 upper fixing plate;

A reclaiming blow pipe, set above the No. 1 lower fixing plate.

As a preferred technical solution of the application, the No. 1 cover-removing module comprises:

No. 1 fixing plate;

No. 4 cylinder, disposed on the upper part of the No. 1 fixing plate;

No. 1 guide bar, set on both sides of the No. 4 cylinder, with one end connected to the No. 1 fixing plate;

No. 3 cylinder, connected to the other end of the No. 1 guide bar;

A holding cylinder, placed on one side of the No. 3 cylinder.

As a preferred technical solution of the application, the rotating module comprises:

A rotary table, disposed on the upper part of the rack;

A bearing, arranged in the upper part of the rotary table;

A rotating motor, mounted under the rotary table.

As a preferred technical solution of the application, the No. 2 cover-removing module comprises:

No. 2 fixing plate, disposed on the upper part of the rack;

No. 5 cylinder, provided in the upper part of the No. 2 fixing plate;

No. 2 guide bar, one end of which is connected with the No. 2 fixing plate, and the other end of which is connected with the cover-removing jaw, whose upper part is provided with a No. 6 cylinder.

As a preferred technical solution of the application, the No. 1 lifting module comprises:

No. 2 lower fixing plate, disposed on the upper part of the rack;

A rotating motor, mounted on one side of the No. 2 lower fixing plate;

An upper fixing plate, disposed above the No. 2 lower fixing plate;

A rotating head, set on the upper part of the upper fixing plate;

No. 1 lifting cylinder, placed below the No. 2 lower fixing plate;

A guide post and guide sleeve, arranged between the No. 2 lower fixing plate and the upper fixing plate.

As a preferred technical solution of the application, the No. 2 lifting module comprises:

No. 3 lower fixing plate, disposed on the upper part of the rack;

No. 2 upper fixing plate, disposed above the No. 3 lower fixing plate;

A guide post and guide sleeve, set between the No. 2 upper fixing plate and the No. 3 lower fixing plate;

A lifting bar, placed above the upper part of the No. 2 upper fixing plate;

No. 2 lifting cylinder, one end of which is connected to one side of the No. 3 lower fixing plate.

One or a plurality of technical solutions provided in the present invention have at least the following technical effects or advantages:

Materials are fed through a rotating disc, and product cutting, waste discharge, air extraction, and product extraction are simultaneously completed at different work stations. The entire movement process is completed automatically, thus realizing automatic feeding of products, all self-cutting, automatic waste discharge, automatic air extraction, and automatic reclaiming. The machine has high degree of automation, high positioning accuracy, high work efficiency, good product effect, and low production cost, being convenient, simple and fast in use.

### BRIEF INTRODUCTION OF THE DRAWINGS

The accompanying drawings are used to provide a further understanding of the application, and constitute a part of the Specification. Together with the embodiments of the application, they are used to explain the application but shall not constitute a limitation to the application.

In the accompanying drawings:

FIG. 1 is a three-dimensional front structural view of a hot angle-cutting automata for earmuff sponge of earphones according to an embodiment of the present invention;

FIG. 2 is a three-dimensional side structural view of a hot angle-cutting automata for earmuff sponge of earphones according to an embodiment of the present invention;

FIG. 3 is a three-dimensional view of the overall structure of a hot angle-cutting automata for earmuff sponge of earphones according to an embodiment of the present invention;

FIG. 4 is a three-dimensional view of core working component groups for a hot angle-cutting automata for earmuff sponge of earphones according to an embodiment of the present invention;

FIG. 5 is a three-dimensional view of the cutter module at cutting station in a hot angle-cutting automata for earmuff sponge of earphones according to an embodiment of the present invention;

FIG. 6 is a three-dimensional view of the sweeping module for a hot angle-cutting automata for earmuff sponge of earphones according to an embodiment of the present invention;

FIG. 7 is a three-dimensional view of the blowing module for a hot angle-cutting automata for earmuff sponge of earphones according to an embodiment of the present invention;

FIG. 8 is a three-dimensional view of the cover-removing & loading module at the material-discharging and product-discharging stations in a hot angle-cutting automata for earmuff sponge of earphones according to an embodiment of the invention;

FIG. 9 is a three-dimensional view of the rotary table module for a hot angle-cutting automata for earmuff sponge of earphones according to an embodiment of the present invention;

FIG. 10 is a three-dimensional view of the cover-removing & loading module at the reclaiming station and the product-collecting station in a hot angle-cutting automata for earmuff sponge of earphones according to an embodiment of the present invention;

FIG. 11 is a three-dimensional view of the lifting module at the cutting station in a hot angle-cutting automata for earmuff sponge of earphones according to an embodiment of the present invention;

FIG. 12 is a three-dimensional view of the lifting module at the reclaiming station in a hot angle-cutting automata for earmuff sponge of earphones according to an embodiment of the present invention.

### NUMBERS IN THE DRAWINGS

Suction module 10, ventilation system 11, intake controller 12, man-machine interface 13, rack 14, button system 15, three-color alarm lamp 16, safety grating module 17, No. 1 leakage module 18, air extraction module 19, hot-cutting module 20, fixing frame 21, Z-direction sliding table 22, XY conditioning mechanism 23, hot cutter 24, air pipe beside the cutter 25, high block 26, power cylinder 27, sweeping module 30, broom 31, No. 1 cylinder 32, No. 2 cylinder 33, fixed seat 34, blowing module 40, column 41, No. 1 upper fixing plate 42, hot cutting exhaust pipe 43, large column 44, reclaiming blow pipe 45, No. 1 lower fixing plate 46, No. 1 cover-removing module 50, No. 3 cylinder 51, No. 1 guide bar 52, No. 4 cylinder 53, No. 1 fixing plate 54, holding cylinder 55, rotating module 60, rotary table 61, rotating motor 62, bearing 63, No. 2 leakage module 111, enclosure 112, No. 2 cover-removing module 70, cover-removing jaw 71, No. 2 guide bar 72, No. 5 cylinder 73, No. 2 fixing plate 74, No. 6 cylinder 75, No. 1 lifting module 80, No. 2 lower fixing plate 81, rotating motor 82, rotating head 83, No. 1 lifting cylinder 84, upper fixing plate 85, guide post and guide sleeve 86, No. 2 lifting module 90, No. 3 lower fixing plate 91, guide post and guide sleeve 92, lifting bar 93, No. 2 lifting cylinder 94, No. 2 upper fixing plate 95.

### DETAILED DESCRIPTION OF THE PREFERRED EMBODIMENTS

In order to make the objectives, technical solutions and advantages of the application clearer, further descriptions are presented below on the invention in detail with reference to the accompanying drawings and embodiments. It shall be understood that the specific embodiments described herein are only used to interpret the application, but not to limit the application.

It shall be noted that when an element is referred to as being “fixed to” or “disposed on” another element, it may be directly on the other element or indirectly on the other element. When an element is said to be “connected to” another element, it may be directly connected to the other element or indirectly connected to the other element.

In the description of the application, it shall be understood that the orientation or positional relationship indicated by the terms such as “length”, “width”, “upper”, “lower”, “front”, “rear”, “left”, “right”, “vertical”, “horizontal”, “top”, “bottom”, “inside”, “outside” are based on the orientation or positional relationship shown in the drawings, which are only for the convenience of describing the application and simplifying the description, rather than indicate or imply that the specified device or element must have a specific orientation, or must be constructed and operated in a specific orientation. Therefore, it shall not be understood as a limitation on the application.

In addition, the terms “No. 1” and “No. 2” are only used for descriptive purposes, and shall not be understood as indicating or implying relative importance or implicitly indicating the number of specified technical features. Hence, the features defined with “No. 1” and “No. 2” may explicitly or implicitly include one or a plurality of these features. In the description of the application, “a plurality of” means two or more than two, unless otherwise specifically defined.

To better understand the above technical solutions, the above technical solutions will be described in detail below in conjunction with the drawings to the specification and specific implementations.

Embodiment 1

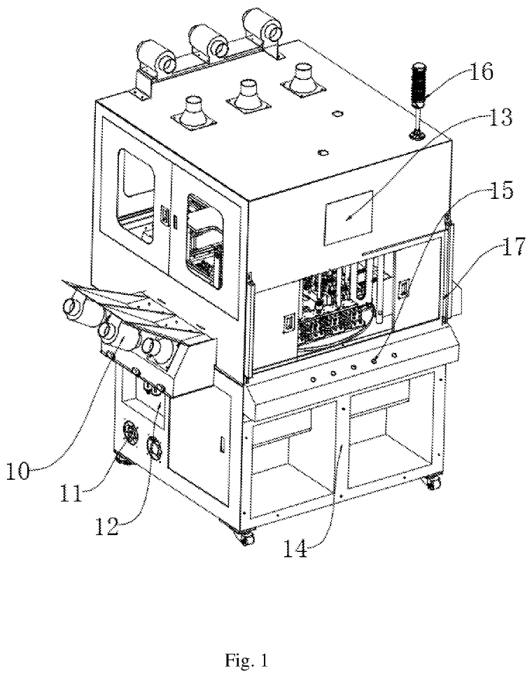

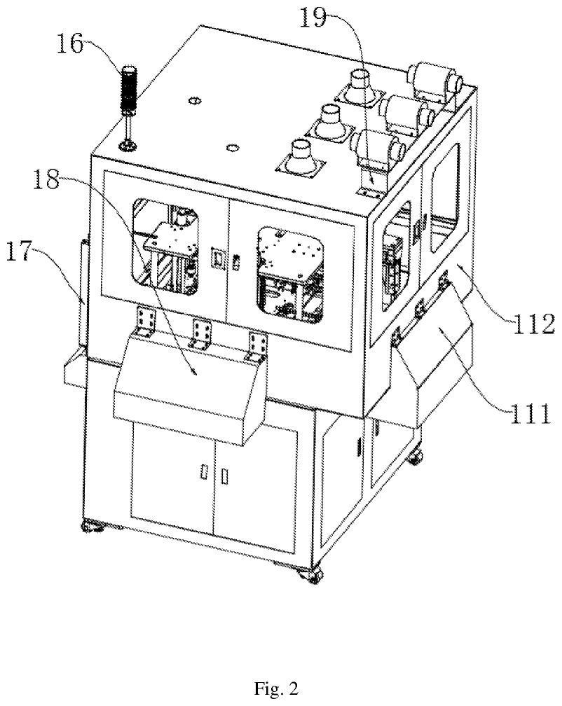

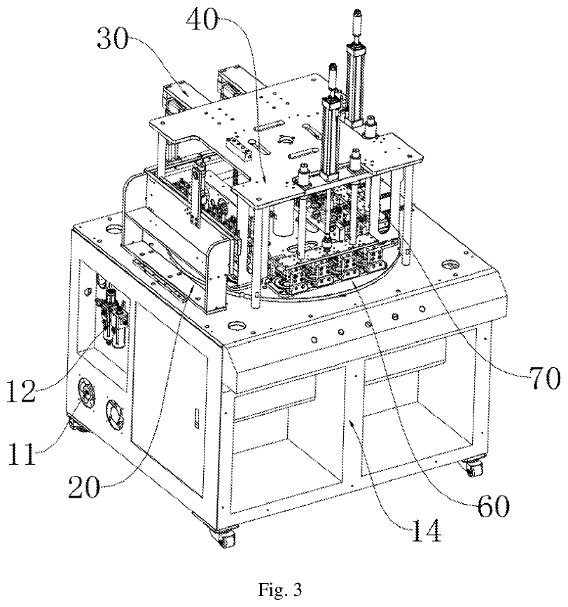

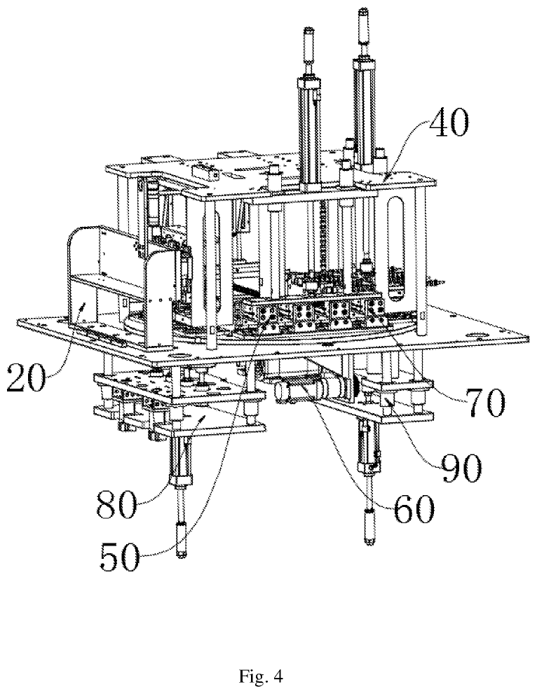

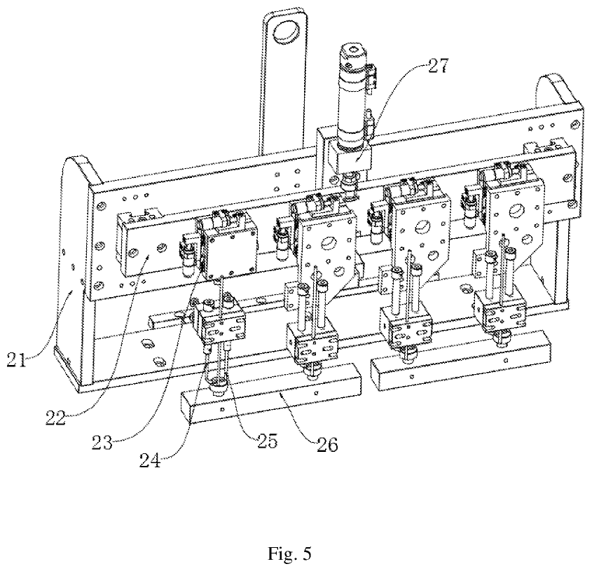

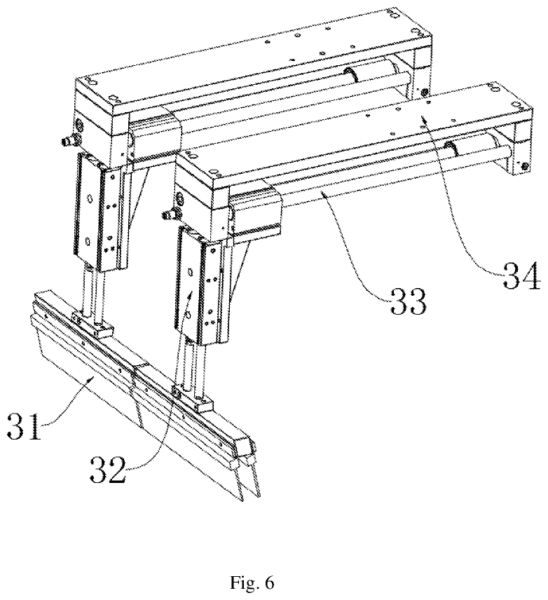

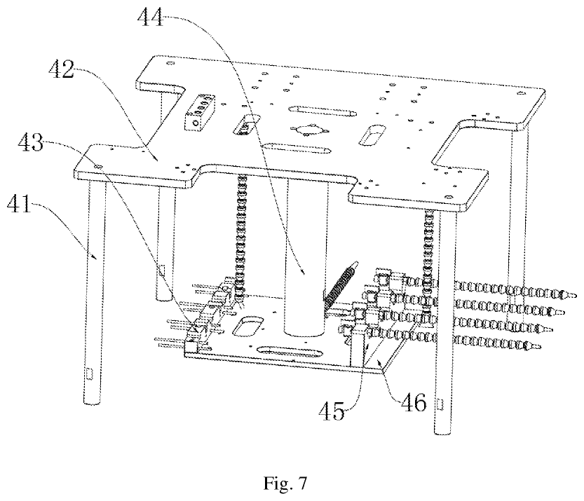

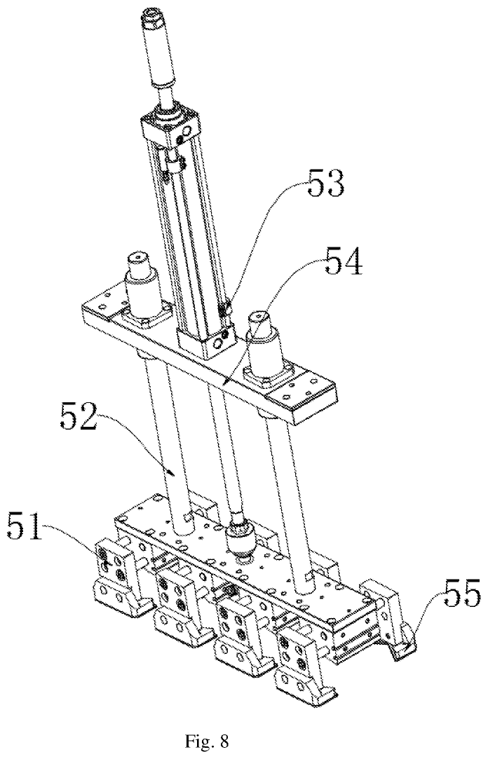

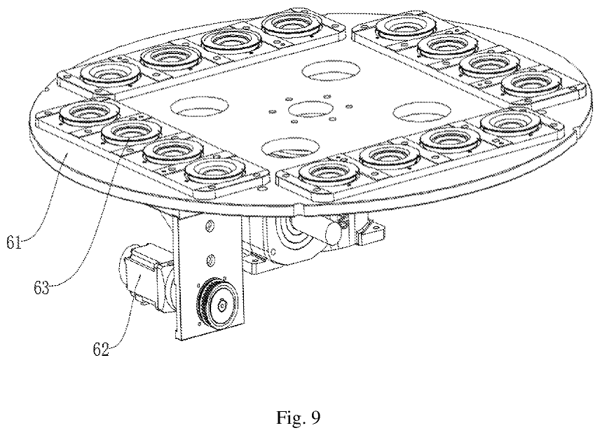

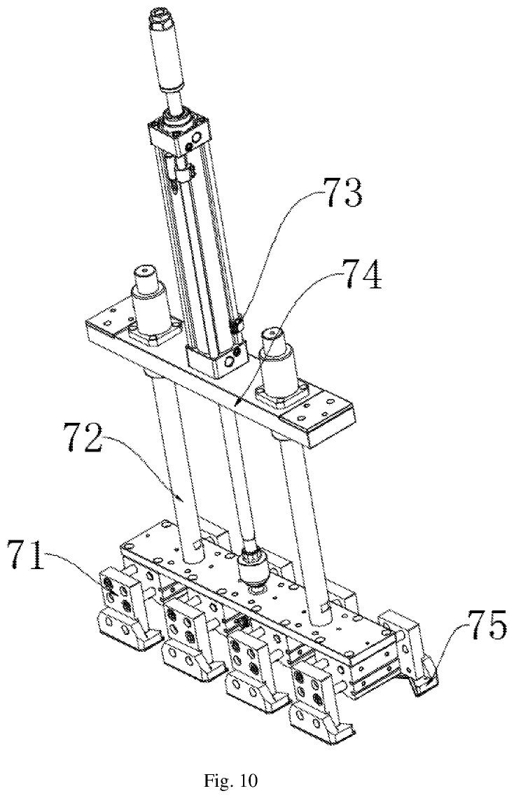

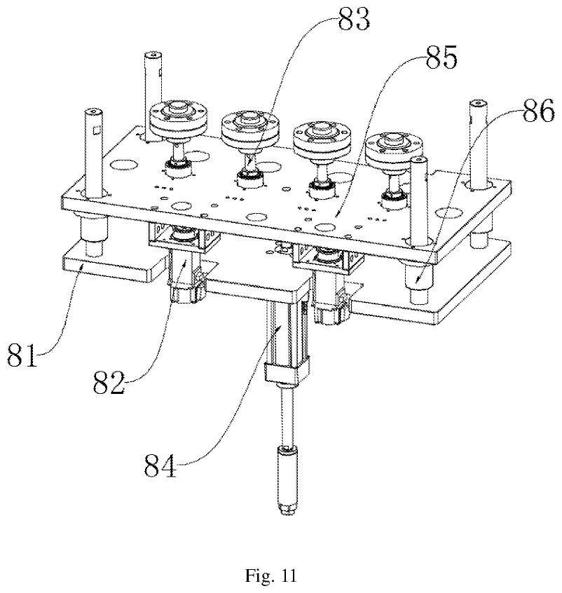

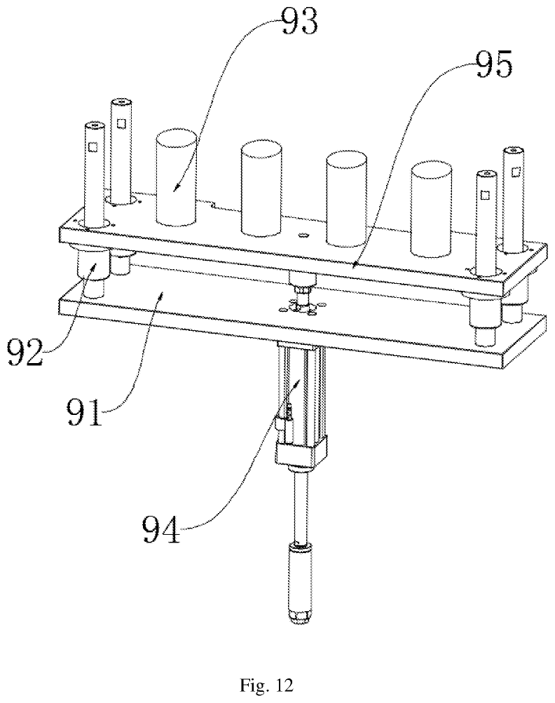

With reference to FIG. 1-12, this application discloses a fully automatic sponge chamfering machine, consisting of:

A rack 14; and

An enclosure 112 disposed on the rack 14; and

An air intake controller 12 and a ventilation system 11 arranged on the rack 14; and

A man-machine interface 13 and a button system 15 set on the enclosure 112; and

A three-color alarm lamp 16 fixed on the enclosure 112; and

A suction module 10 set on the enclosure 112; and

A safety grating module 17 set on the enclosure 112; and

An air extraction module 19 set on the enclosure 112; and

No. 1 leakage module 18 and no. 2 leakage module 111 set on the enclosure 112; and

Hot-cutting module 20, sweeping module 30, blowing module 40, No. 1 cover-removing module 50 at the loading station, rotating module 60, No. 2 cover-removing module 70 at the reclaiming station, No. 1 lifting module 80 at the hot cutting station, and No. 2 lifting module 90 at the reclaiming station.

Place the products flatly in the bearing 63 on the rotating module 60, four at a time. After that, press the start key in the button system 15 to initiate the process. The No. 4 cylinder 53 and No. 3 cylinder 51 in the No. 1 cover-removing module 50 at the material discharging position act, and the cover plate is placed on the bearing 63. On completion, the rotary table 61 is driven by the rotating motor 62 to turn 90 degrees. When the product moves to the hot cutting station, the No. 1 lifting module 80 comes into action. Once being lifted in place, the hot-cutting module 20 starts its downward movement. When the hot cutter 24 touches sponge products, the rotating mechanism 83 in the No. 1 lifting module 80 starts to rotate, and drives the bearing 63 on the rotating module 60 to turn. Hot cutting begins at this time. Since the hot cutting generates a large amount of stimulating gas, the suction module 10 and the air extraction module 19 started to work to extract the gas from the machine. In addition, the hot cutting exhaust pipe 43 and the air pipe beside the cutter 25 in the blowing module 40 start to blow strongly to blow up the cut sponge waste such that it is separated from the products. When the bearing 63 on the rotating module 60 rotates one cycle, the product is cut out. At the same time as this cutting, the material-discharging station begins to place the products flatly in the bearing 63 on the rotating module 60, four at a time. After that, press the start key in button systeml5 to initiate the next process again. The No. 4 cylinder 53 and No. 3 cylinder 51 in the No. 1 cover-removing module 50 at the material discharging position act, and the cover plate is placed on the bearing 63. After completion, the rotary table 61 is driven by the rotating motor 62 to turn 90 degrees so that the product moves to the hot cutting station, and the product previously cut moves to the sweeping station. The hot cutting station repeats the above process. At this time, the No. 1 cylinder 32 and No. 2 cylinder 33 in the sweeping module 30 drive the broom 31 back and forth to sweep away the sponge waste at the rotary table 61 and the bearing 63. At the same time as this cutting, the material-discharging station begins to place the products flatly in the bearing 63 on the rotating module 60, four at a time. After that, press the start key in the button system 15 to initiate the process again. The No. 4 cylinder 53 and No. 3 cylinder 51 in the No. 1 cover-removing module 50 at the material discharging position act, and the cover plate is placed on the bearing 63. After completion, the rotary table 61 is driven by the rotating motor 62 to turn 90 degrees so that the product moves to the hot cutting station, the product previously cut moves to the sweeping station, and the last sweeping station moves to the reclaiming station.

The hot cutting station repeats the above hot cutting process, and the waste sweeping station repeats the above sweeping process. At this time, the No. 2 cover-removing module 70 at the reclaiming station comes into action, removing the cover plate on the bearing 63, and the No. 2 lifting module 90 comes into action, lifting the product from the bearing 63.

Wherein the hot-cutting module 20 comprises a fixing frame 21, a Z-direction sliding table 22, an XY conditioning mechanism 23, a hot cutter 24, an air pipe beside the cutter 25, a high block 26, and a power cylinder 27 that provides the hot-cutting module 20 with overall power.

Wherein the sweeping module 30 comprises a broom 31, a vertically-extended No. 1 cylinder 32, No. 2 cylinder 33 for sweeping, and a fixed seat 34, wherein the No. 1 cylinders 32 and No. 2 cylinder 33 provide power for the sweeping operation.

Wherein the blowing module 40 comprises a column 41, No. 1 upper fixing plate 42, a hot cutting exhaust pipe 43, a large middle column 44, a reclaiming blow pipe 45, and No. 1 lower fixing plate 46.

Wherein the No. 1 cover-removing module 50 at the material-discharging position comprises No. 3 cylinder5l, No. 1 guide bar 52, No. 4 cylinder 53, No. 1 fixing plate 54, holding cylinder 55, wherein the No. 4 cylinder 53 provides power for removing covers, and the cylinder 55 provides power for clamping covers.

Wherein the rotating module 60 shall further comprise a rotating table 61, a bearing 63, and a rotating motor 62.

Wherein the No. 2 cover-removing module 70 comprises a cover-removing jaw 71, No. 2 guide bar 72, No. 5 cylinder 73, No. 2 fixing plate 74, No. 6 holding cylinder 75, wherein the No. 5 cylinder 73 provides power for removing covers, and the No. 6 cylinder 75 provides power for clamping covers.

Wherein the No. 1 lifting module 80 at the cutting station shall comprise No. 2 lower fixing plate 81, a rotating motor 82, rotating head 83, No. 1 lifting cylinder 84, an upper fixing plate 85, a guide post and guide sleeve 86, wherein the cylinder 84 provides power for lifting up and down, and the motor 82 provides power for rotation.

Wherein the No. 2 lifting module 90 at the material-receiving station shall comprise No. 3 lower fixing plate 91, a guide post and guide sleeve 92, a lifting bar 93, No. 2 lifting cylinder 94, No. 2 upper fixing plate 95, wherein the cylinder 94 provides power for lifting and reclaiming.

Repeated and continuous operation is started in this way, so that the products placed in are continuously cut, discharged, reclaimed, and exhausted. The whole process automatically completes the transportation and positioning of objects at required stations, without manual operation. The machine has high positioning accuracy, good cutting quality, accurate cutting size, stable quality, high degree of automation, high work efficiency, good finished product effect, and high rates of finished products.

The present invention discloses a hot angle-cutting automata for earmuff sponge of earphones, which consists of a set of rack, a rotary table module disposed on the rack that can realize four-station cyclic movement, a rotatable sponge-holding base module set on the rotary table module to ensure that round and oval sponges are fixed in a specific cavity, a cover-removing module arranged in the loading station to enable products compacted in the base, a cutter module and a lifting module set at the cutting station to cut products into the required shape and size, a sweeping module set at the sweeping station to completely remove the remaining sponge, a lifting and cover-removing module set at the material-discharging station to take qualified products from the machine, a suction module set at the rack cutting station to extract scrap, an air extraction module mounted on the top of the rack to extract the resultant stimulating gas out of the machine, and a man-machine interface module fixed on the rack used for the entire machine control. The whole process automatically completes the transportation and positioning of objects, without manual operation. The machine has high positioning accuracy, good cutting quality, accurate cutting size, stable quality, high degree of automation, high work efficiency, good finished product effect, and high rates of finished products. It is a hot angle-cutting automata for earmuff sponge of earphones, being convenient, simple and fast in use

Finally, it shall be noted that the above descriptions are only preferred embodiments of the application, and are not intended to limit the application. Although the application has been described in detail with reference to the foregoing embodiments, those skilled in the art may still modify the technical solutions described in the foregoing embodiments, or equivalently replace some of the technical features. Any modification, equivalent replacement, improvement, etc., made within the spirit and principle of the application shall be included in the protection scope of the application.

What is claimed is:

1. A fully automatic sponge chamfering machine, wherein it consists of:
a rack (14); and
an enclosure (112) disposed on the rack (14); and
an air intake controller (12) and a ventilation system (11) arranged on the rack (14); and
a man-machine interface (13) and a button system (15) set on the enclosure (112); and
a three-color alarm lamp (16) fixed on the enclosure (112); and
a suction (10) module set on the enclosure (112); and
a safety grating module (17) set on the enclosure (112); and
an air extraction module (19) set on the enclosure (112); and
No. 1 leakage module (18) and No. 2 leakage module (111) set on the enclosure (112); and
a hot-cutting module (20), a sweeping module (30), a blowing module (40), No. 1 cover-removing module (50), a rotating module (60), No. 2 cover-removing module (70), No. 1 lifting module (80) and No. 2 lifting module (90).

2. A fully automatic sponge chamfering machine according to claim 1, wherein the hot-cutting module (20) comprises:
a fixing frame (21), fixed to the upper part of the rack (14);
a Z-direction sliding table (22), set on one side of the fixing frame (21);
an XY conditioning mechanism (23), set on one side of the Z-direction sliding table (22);
a hot cutter (24), arranged below the XY conditioning mechanism (23), with one side connected to the air pipe (25) beside the cutter;
a high block (26), located below the air pipe (25) beside the cutter;
a power cylinder (27), arranged on the upper part of the fixing frame (21).

3. A fully automatic sponge chamfering machine according to claim 1, wherein the sweeping module (30) comprises:
a fixed seat (34), disposed in the upper part of the rack (14);
No. 2 cylinder (33), disposed below the fixed seat (34);
No. 1 cylinder (32), one end of which is connected to one end of the No. 2 cylinder (33)
a broom (31), set below the No. 1 cylinder (32).

4. A fully automatic sponge chamfering machine according to claim 1, wherein the blowing module (40) comprises:
No. 1 upper fixing plate (42), disposed above the rack (14);
a large column (44), the top of which is connected to the No. 1 upper fixing plate (42);
No. 1 lower fixing plate (46), set below the large column (44);
a hot cutting exhaust pipe (43), provided in the upper part of the No. 1 lower fixing plate (46);
a column (41), one end of which is connected to the bottom of the No. 1 upper fixing plate (42);
a reclaiming blow pipe (45), arranged above the No. 1 lower fixing plate (46).

5. A fully automatic sponge chamfering machine according to claim 1, wherein the No. 1 cover-removing module (50) comprises:
No. 1 fixing plate (54);
No. 4 cylinder (53), disposed in the upper part of the No. 1 fixing plate (54);
No. 1 guide bar (52), disposed on both sides of the No. 4 cylinder (53), with one end connected to the No. 1 fixing plate (54);
No. 3 cylinder (51), connected to the other end of the No. 1 guide bar (52);
a holding cylinder (55), arranged on one side of the No. 3 cylinder (51).

6. A fully automatic sponge chamfering machine according to claim 1, wherein the rotating module (60) comprises:
a rotary table (61), provided in the upper part of the rack (14);
a bearing (63), disposed in the upper part of the rotary table (61);
a rotating motor (62), set under the rotary table (61).

7. A fully automatic sponge chamfering machine according to claim 1, wherein the No. 2 cover-removing module (70) comprises:
No. 2 fixing plate (74), provided in the upper part of the frame (14);
No. 5 cylinder (73), disposed in the upper part of the No. 2 fixing plate (74);
No. 2 guide bar (72), one end of which is connected with the No. 2 fixing plate (74), and the other end of which is connected with a cover-removing jaw (71), whose upper part is provided with No. 6 cylinder (75).

8. A fully automatic sponge chamfering machine according to claim 1, wherein the No. 1 lifting module (80) comprises:
No. 2 lower fixing plate (81), disposed in the upper part of the frame (14);
a rotating motor (82), mounted on one side of the No. 2 lower fixing plate (81);
an upper fixing plate (85), disposed above the No. 2 lower fixing plate (81);
a rotating head (83), set on the upper part of the upper fixing plate (85);
No. 1 lifting cylinder (84), provided below the No. 2 lower fixing plate (81);
a guide post and guide sleeve (86), arranged between the No. 2 lower fixing plate (81) and the upper fixing plate (85).

9. A fully automatic sponge chamfering machine according to claim 1, wherein
the No. 2 lifting module (90) comprises:
No. 3 lower fixing plate (91), provided in the upper part of the frame (14);
No. 2 upper fixing plate (95), disposed above the No. 3 lower fixing plate (91);
a guide post and guide sleeve (92), set between the No. 2 upper fixing plate (95) and the No. 3 lower fixing plate (91);
a lifting bar (93), provided in the upper part of the No. 2 upper fixing plate (95);
No. 2 lifting cylinder (94), one end of which is connected to one side of the No. 3 lower fixing plate (91).
